(19) United States
(12) Patent Application Publication
(10) Pub. No.: US 2011/0289966 A1
(43) Pub. Date: Dec. 1, 2011

(54) FINGER RING WITH SIZE-ACCOMMODATING INNER LINER

(75) Inventors: Ted E. Ahrenholtz, Minnetonka, MN (US); Justin Paul Boortz, Waconia, MN (US)

(73) Assignee: BLUEROCK TECHNOLOGIES, INC., Minneapolis, MN (US)

(21) Appl. No.: 13/112,178

(22) Filed: May 20, 2011

Related U.S. Application Data
(60) Provisional application No. 61/348,897, filed on May 27, 2010.

(51) Int. Cl. A44C 9/02; B23P 13/00

(52) U.S. Cl. 63/15.6; 29/8

(57) ABSTRACT

A finger ring is provided which includes a size-accommodating inner liner formed of a pliable, flexible and resilient material throughout and adhered to the inner diametrical surface of the ring. The liner includes a plurality of peripherally spaced flexible ribs extending inwardly therefrom to help facilitate ease of placement and removal of the ring from a person's finger, and to facilitate adjustment to and/or accommodation of variances in ring sizes. The outer substrate of the ring is formed with a liner retention shoulder to help retain the liner and resist shearing forces subjected thereto upon transition of the ring on and off the finger. The ring may be configured to permit simultaneous formation of aesthetically pleasing designs on the outer surface of the ring during the overmolding process utilized to form the inner liner therefor.

### CROSS REFERENCE TO RELATED APPLICATIONS

This application claims the benefit of U.S. Provisional patent application No. 61/348,897, filed on May 27, 2010 by the same inventors, namely, Ted E. Ahrenholtz and Justin P. Boortz, and entitled “FINGER RING WITH SIZE-ACCOMODATING INNER LINER,”, the entire disclosure of which is incorporated herein by reference thereto.

### TECHNICAL FIELD

The present invention relates generally to the field of finger rings, and more particularly to finger rings that are constructed to facilitate accommodation of multiple finger sizes and/or address sizing issues caused by aging, weight gain or loss, injury, arthritic conditions, etc.

### BACKGROUND OF THE INVENTION

The ability to properly size a finger ring has been a longstanding unresolved problem. Human body types can vary widely. Although largely determined by genetics, the size and shape of a person's hands and fingers can change substantially over time as a result of aging, diet and other conditions such as injury, arthritis, etc. The distal and proximal interphalangeal joints connecting the phalanges of the fingers can vary significantly in size. For various reasons, the proximal interphalangeal joint (i.e., the “knuckle joint”) is oftentimes substantially enlarged relative to the finger phalanges it connects, thereby causing a significant disparity in finger diameter. For typical finger rings of fixed diameter, this can be problematic in that the ring is either too tight to slide over the knuckle, or too loose on the proximal phalanx where the ring seats, resulting in constant irritation from undesirable persistent rotation of the ring on the finger.

Many attempts have heretofore been made to resolve the above problem. The use of an adhesive tape wrapped around the base (palm side) of the ring is often used to provide a better fit of a ring and prevent rotation on the finger. However, the tape is unsightly, usually absorbs water and perspiration, and eventually wears out and becomes compressed through repeated passage over the knuckle. Thus, frequent and time consuming replacement of the tape is required. Various mechanical devices have also been employed in an attempt to account for variations in finger size and prevent unwanted rotation of the ring on the finger. For example, ring inserts utilizing mechanical leaf springs and resilient deformable materials have been known to be installed on the inner ring surface to help account for and adjust to the variations in finger size.

Such mechanical devices, however, are oftentimes uncomfortable and susceptible to breakage through repeated placement and removal of the ring upon the finger. Such devices are typically mounted to the base of the ring, exerting pressure only to a localized region of the finger, which causes discomfort. Repeated transition of the ring over the knuckle also imparts a repeated transverse or axial “shearing” force to such devices that tends to dislodge them from the inner surface of the ring over time. This, along with everyday wear and tear on the ring, eventually causes the device to shear or pull away from the inner ring surface to which it has been mounted. Other sizing devices have been implemented which extend completely around the inner perimeter of a ring for better comfort, but have also proven to be susceptible to damage from transitional shearing forces and/or are complicated in design.

These aforementioned problems with finger rings have frustrated the jewelry industry for many years. With myriad finger sizes and shapes, manufacturers and retailers alike have found it necessary to carry large inventories of different and varying ring sizes to accommodate the needs of the industry. These large inventories are costly to maintain. Consequently, it is evident that there is a distinct need for a finger ring that is capable of accommodating reasonable variances in ring size, is comfortable and easy to put on and take off, is durable for extended use without degradation, and is aesthetically pleasing to the eye.

### BRIEF SUMMARY OF THE INVENTION

In the present invention, a finger ring is provided which includes a size-accommodating inner liner formed substantially throughout of a pliable, flexible and resilient material. The inner liner is adhered to and extends at least partly around the inner diametrical surface of the outer substrate or band of a finger ring. Although it is preferred that the liner extend completely around the inner diametrical surface of the finger ring, with the improved comfort and structural integrity provided by the liner design, it is contemplated that the liner could extend only partly around and still provide the benefits described herein.

In one exemplary embodiment, the outer substrate of the ring may be formed of a substantially rigid material, comprising without limitation, a suitable metal or plastic material, or a combination of both. The inner liner may be formed throughout of a relatively flexible, pliable elastomeric material, such as silicone rubber, although it is also conceivable that the liner could be formed of other flexible plastics or thermoplastic elastomers, or a combination thereof, without departing from the invention herein. The liner is preferably constructed of a self-adhering material having a high resistance to the aggressive additives typically found in hand lotions, such as Stearic Acid and Glycol. The liner may then be overmolded to the inner surface of the outer ring substrate, thereby causing the liner to adhere to and extend peripherally around the inner diametrical surface thereof. The liner may also extend substantially across the entire axial width of the ring substrate to enhance the comfort of the ring, which will be described in more detail hereafter.

A plurality of peripherally spaced flexible ribs or protuberances are formed on the liner and extend radially inward therefrom to help facilitate ease of placement and removal of the ring from a person's finger, and to facilitate adjustment to and/or accommodation of variances in ring sizes. In one embodiment, each of the ribs extends generally longitudinally across at least a portion of the axial width of the liner. Each rib is constructed with a generally thin profile that tapers radially inwardly from the inner peripheral surface of the liner, thereby forming a plurality of flexible, resilient rib elements that are configured to readily fold or roll over upon rotation of the ring during placement or removal of the ring upon a finger. By folding over, the flexible ribs facilitate passage of the ring over the generally enlarged knuckle joint of the finger. After passing over the knuckle region, the ribs tend to relax to their original state. This prevents rotation and facilitates proper seating of the ring on the proximal phalanx of the finger; it also enhances the ability for the finger to breathe better underneath the ring.

In another exemplary embodiment, the inner diametrical surface of the outer ring substrate is configured with a liner retention shoulder formed adjacent at least one of the peripheral axial edges of the substrate for helping to retain the liner and resist the “shearing” forces subjected thereto upon transition of the ring on and off the finger. In one embodiment, a liner retention shoulder is formed adjacent each opposite peripheral edge portion of the outer ring substrate, thereby defining a central plateau that extends peripherally around the inner diametrical surface of the ring substrate. The liner then contours and adheres to the profile of the inner diametrical surface of the outer substrate of the ring in interengaging relation, so that much of the “shearing” forces imparted to the liner upon placement or removal of the ring upon the finger are directed into and absorbed by the shoulders formed in the ring substrate.

In still another exemplary embodiment, the outer diametrical surface of the ring substrate may be formed with one or more channel regions or depressions that form an aesthetically pleasing design of choice. These channels may then be configured to connect with one or more flow-through weep holes extending between the inner and outer diametrical surfaces of the ring substrate. This allows the liner material, while in its molten state during the overmolding process, to freely flow from one surface of the substrate to the other. Consequently, the molten liner material is permitted to flow into the channel regions in the outer surface of the ring substrate and adhere thereto to form an outer aesthetically pleasing design to the ring. Notably, once the liner material cures into a hardened state, the liner material extending through the weep holes to the outer surface of the ring will also function as an added retention member helping to secure the liner to the inner diametrical surface of the ring substrate and further prevent dislodgement therefrom.

Example embodiments are also provided herewith for methods for accommodating ring transition and ring fit on fingers of varying sizes. In one example embodiment, a method generally includes providing a ring with an inner diametrical liner having a plurality of flexible, resilient ribs or protuberances which tend to roll over upon rotation of the ring during placement or removal thereof from a finger. In another embodiment, the method generally includes providing an outer ring substrate with a liner retention shoulder that will help to absorb potential “shearing” forces and improve comfort upon placement or removal of the ring upon a finger.

Further areas of applicability will also become apparent from the description provided herein. The description and specific examples in this summary are intended for purposes of illustration only and are not intended to limit the scope of the present disclosure.

### BRIEF DESCRIPTION OF THE DRAWINGS

These and other objects and advantages of the invention will more fully appear from the following description, made in connection with the accompanying drawings, wherein like reference characters refer to the same or similar parts throughout the several views, and in which:

FIG. 1 is a perspective view of an exemplary embodiment of a finger ring constructed in accordance with the present invention;

FIG. 2 is a front elevation view of the finger ring shown in FIG. 1;

FIG. 2A is a close-up front elevation view of one of the liner ribs from the finger ring shown in FIG. 2, showing the construction detail thereof;

FIG. 2B is a front elevation view of a finger ring similar to that shown in FIG. 2, showing the function of the inner liner ribs upon rotation of the ring onto a person's finger;

FIG. 3 is a cross-sectional view of another exemplary embodiment of a finger ring similar to that shown in FIG. 2, showing the inter-engagement of the inner liner with the outer ring substrate;

FIG. 4A is a cross-sectional view of the finger ring shown in FIG. 3, with the inner liner removed to better show the profile of the outer ring substrate;

FIG. 4B is a close-up fragmentary view of a liner retention shoulder formed in the outer ring substrate shown in FIG. 4A;

FIG. 5 is another exemplary embodiment of a finger ring constructed in accordance with the present invention and configured to form designs in the outer ring surface.

### DETAILED DESCRIPTION OF THE INVENTION

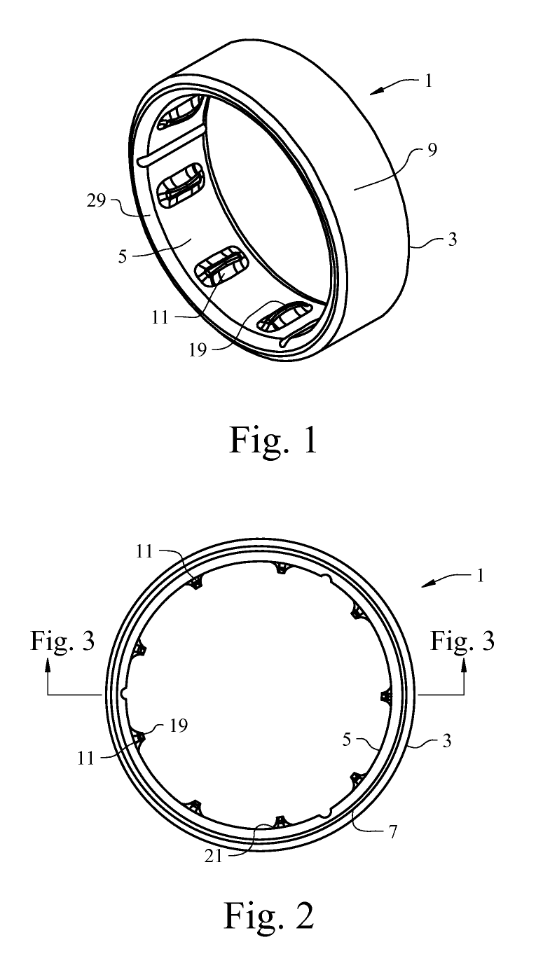

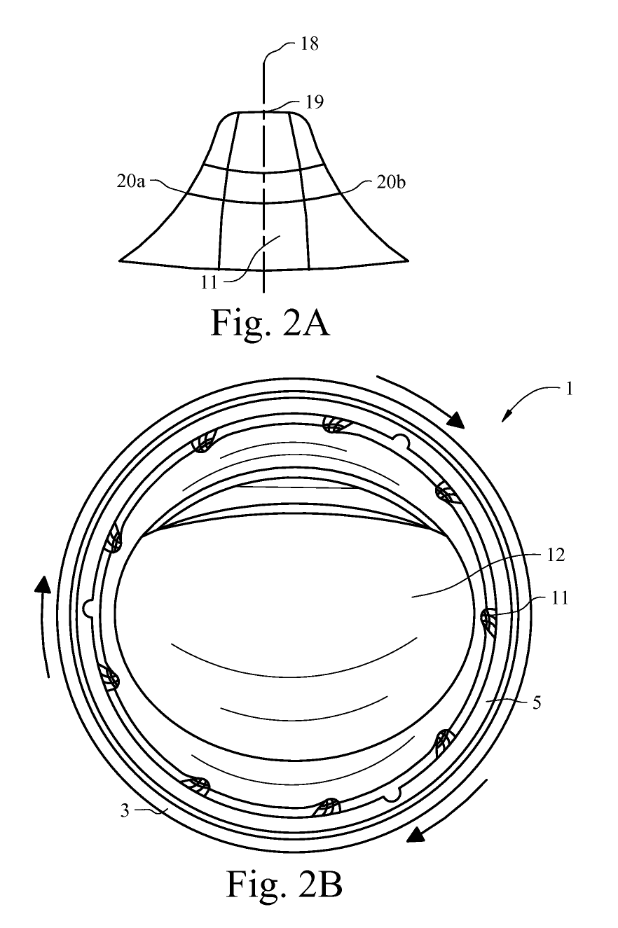

With reference to FIGS. 1 and 2 of the drawings, a finger ring 1 is shown constructed in accordance with the present invention. Ring 1 is comprised generally of an outer annular substrate or band 3 to which an inner liner 5 is fixedly secured. As shown, liner 5 is adhered to the inner diametrical surface 7 of the outer substrate 3 offing 1, and extends around the entire inner periphery of substrate 3. While liner 5 extends completely around the inner periphery of substrate 3 in the embodiment shown, it is conceivable that liner 5 could extend only partly around substrate 3 without departing from the invention herein. For example, on a ring 1 having decorative indicia on a portion of the outer surface 9 of the ring substrate 3, it may be desirable for liner 5 to extend only along the inner base portion of substrate 3 opposite the decorative indicia. In the embodiment shown, liner 5 also extends completely across the axial width of substrate 3 for enhanced comfort to the wearer of the ring 1, but it is contemplated that liner 5 could stop short of the axial edge portions 15 and 17 of substrate 3 without departing from the invention herein.

In one exemplary embodiment, it is contemplated that the outer substrate 3 of ring 1 be formed of a substantially rigid metallic material, such as gold, platinum or titanium. Here again, however, it is conceivable that other substantially rigid materials could be used in the formation of substrate 3, such has a relatively rigid plastic material, ceramic, or any combination of such materials. For purposes of the intended invention, it is desirable that inner liner 5 be formed throughout of a relatively flexible, pliable and resilient material, such as a thermoplastic elastomer (TPE). In a preferred embodiment of the invention, the use of a self-adhering silicone rubber is contemplated because it exhibits each of these characteristics. Silicone rubber is also known for its superior durability and ability to be formulated to resist aggressive additives that are often found in hand lotions, etc., such as Stearic Acid and Glycol; and, silicone rubber is also a readily moldable plastic material that is suitable for use in an overmolding process such as that preferred for adhering liner 5 to substrate 3 of ring 1 (discussed in more detail hereafter).

A plurality of flexible ribs or protuberances 11 are formed on the inner diametrical surface 13 of liner 5 to help facilitate ease of placement and removal of the ring from a person's finger 12 (see, FIG. 2B), and to facilitate adjustment to and/or accommodation of variances in ring sizes. As shown in the drawings, ribs 11 are peripherally spaced along surface 13 of liner 5 and constructed to protrude radially inward therefrom. Although ribs 11 are depicted in the drawings at regularly spaced intervals about the periphery of liner 5, ribs 11 could also be irregularly spaced without departing from the invention herein.

Each of the plurality of ribs 11 extends generally longitudinally across at least a portion of the axial width of the liner 5. As shown, in one embodiment, each rib 11 extends axially across the central portion of the liner 5, but stops short of either opposing axial edge 15 or 17 thereof. It has been found that this helps to avoid the potential for any showing of visible markings on the finger 12 caused by such ribs outside the confines of the ring 1. It has been found that shortening the extension of the ribs 11 to terminate approximately 1.00 mm from the liner edges 15 and 17 will prevent any showing of finger markings outside the confines of ring 1. Notwithstanding the above, it is certainly contemplated that such ribs 11 could extend completely to edges 15 and 17 without affecting the functional aspects or departing from the spirit of the invention herein.

As shown best in FIGS. 2 and 2A, each rib 11 is also constructed with a generally thin profile that tapers radially inwardly from the inner peripheral surface 13 of liner 5 to an apex 19 at its innermost point. More particularly, each rib has a central radial axis 18 and a pair of opposing circumferentially-spaced rib sidewalls 20a and 20b which curve or arch inwardly toward one another and toward the central axis 18 of the rib. Each rib 11 continues to radius slightly inwardly on each of its sides 20a and 20b adjacent its base 21 to enhance the structural integrity of the rib and help promote the ability of the rib to flex and fold over when rotated over the knuckle region of a finger 12.

As shown best in FIG. 2B, the resulting configuration is a plurality of flexible, resilient rib elements 11 that are designed to readily fold or roll over upon rotation of the ring during placement or removal of the ring upon a finger 12. By folding over, the flexible ribs 11 facilitate passage of the ring 1 over the generally enlarged knuckle region of the finger 12. After passing over the knuckle region, the ribs 11 tend to relax to their original state, substantially as shown in the drawings. The ribs 11 then function to frictionally engage the proximal phalanx of the finger 12, thereby preventing rotation and facilitating proper seating of the ring on the finger. In order to enhance the comfort level of ring 1 on the finger 12, the apex portion 19 of each rib is slightly flattened or rounded on top to eliminate any sharp edges from contacting or pinching the skin. As an added benefit, the radially inward protrusion of ribs 11 also enhance the ability for the finger to breathe underneath the ring, thereby helping to reduce perspiration of the finger under ring 1.

Another significant advantage provided by ribs 11 is the ability for each ring 1 to accommodate multiple finger sizes comfortably, and account for changes or variances in finger size due to aging, weight gain or loss, arthritic conditions, injury, etc. Ring sizing varies between countries, but in the United States, rings are typically sized in ¼ increments (e.g., size 6, 6¼, 6½, 6¾, 7, etc.). Each sizing increment correlates to approximately 0.008 inch variance in inside diameter, or about 0.32 inch total for each full size range (e.g., size 6 through 6¾). Because of the highly pliable, flexible and resilient nature of ribs 11 and their ability to readily fold over when transitioning over the knuckle, it has been found that by appropriately dimensioning the height of each rib 11 (from the inner surface 13 of liner 5 to its apex 19) to be in the approximate range of about 0.06 to 0.07 inch, each ring 1 incorporating liner 5 with ribs 11 can be utilized to comfortably accommodate a full range of at least two (2) complete finger sizes (e.g., size 6 through 7¾). This is significant in that heretofore ring manufacturers and retailers have been required to carry enormous inventories of rings covering all different sizes, in every style, to ensure that they can meet the needs of their customers. With the use of the present invention, the size of these massive inventories can be significantly reduced.

To provide the benefits and advantages described herein, it has been found that the use of silicone rubber having Durometer hardness value falling within the approximate range of 20 to 70 Duro Shore A is acceptable for use in the formation of liner 5; however, for optimal conditions, it is preferred that the hardness value be about 40 Duro Shore A. Although the use of silicone rubber is deemed preferable, it will be understood that the use of other materials is also conceivable, provided such materials are flexible, pliable and sufficiently resilient to facilitate performance of the present invention for its intended purpose. For instance, it is contemplated that other TPE materials or thermoset rubber materials, such as ethylene propylene diene monomer (EPDM), Nitrile, etc., having a similar hardness value range may also be suitable for use in the present invention. Also, it is possible that thermoplastic urethane (TPU) materials of similar hardness may be capable of providing the flexibility and resiliency to adequately function in the present invention. It is also conceivable that any combination of the above materials, or other known flexible and resilient materials, could be utilized in the formation of liner 5 without departing from the invention herein.

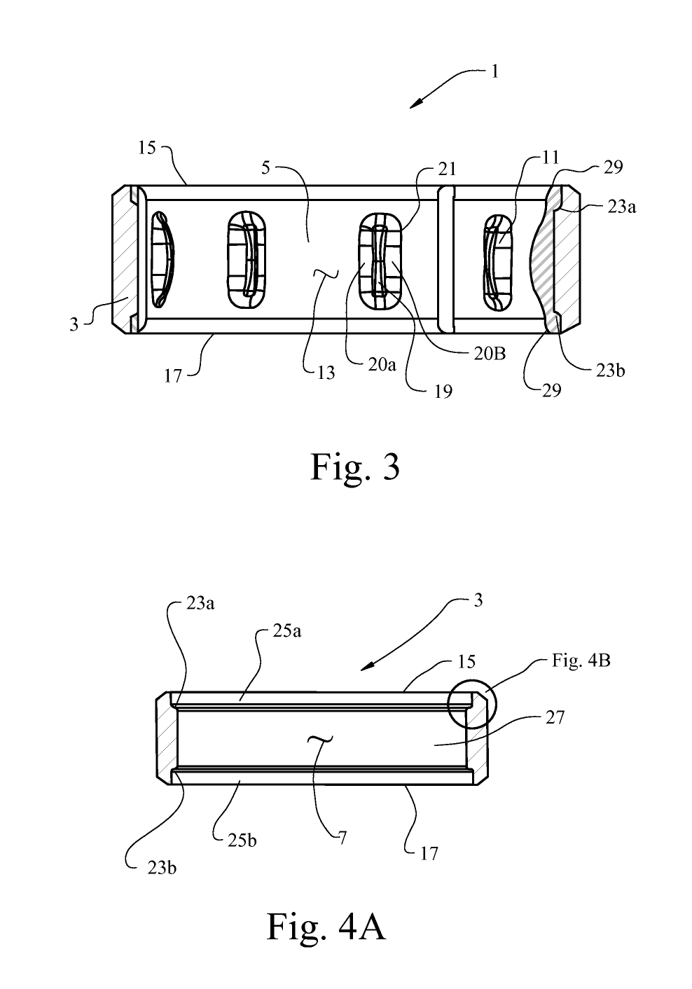

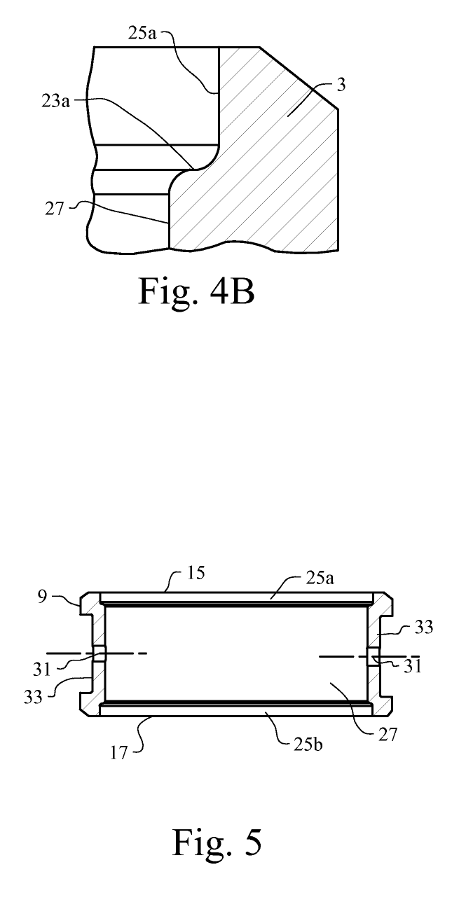

In another exemplary embodiment, as shown best in FIGS. 4A and 4B, the inner diametrical surface 7 of the outer ring substrate 3 is configured with liner retention shoulders 23a and 23b formed adjacent the opposite peripheral axial edges 15 and 17 of the substrate 3. These retention shoulders 23a and 23b help to resist the “shearing” forces subjected to liner 5 upon movement of the ring 1 on and off the finger 12, thereby enhancing the retention of liner 5 on substrate 3. As shown, shoulder portions 23a and 23b are defined by the transition or step-back between the peripheral lands 25a and 25b formed at edges 15 and 17 of substrate 3 and the central raised portion or plateau 27 which extends either partially or completely around the periphery of the inner diametrical surface 7 thereof. Once liner 5 is adhered to substrate 3, as seen in FIG. 3, it contours and interengages the profile of the inner diametrical surface 7 of substrate 3 in such manner that much of the axial “shearing” forces imparted to liner 5 upon placement or removal of the ring 1 upon a finger are directed into and absorbed by the shoulders 23a and 23b formed in substrate 3. Consequently, an improved structural integrity is realized between liner 5 and substrate 3 which substantially improves the resistance to axial shearing forces that have tended to dislodge and damage conventional liners heretofore utilized in the prior art. This step-back feature between liner 5 and substrate 3 also facilitates the ability to provide a more generous fillet or radius on the peripheral leading edge 29 on each side of liner 5, thereby enabling a smooth, comfortable insertion of the ring 1 onto the wearer's finger 12.

As shown in FIG. 5, in still another exemplary embodiment, aesthetically pleasing ring designs may be formed on the outer surface 9 of the ring 1 simultaneously with the formation and adherence of liner 5 thereto. As shown, substrate 3 of ring 1 may be configured with one or more flow-through apertures or weep holes 31 extending between the inner diametrical surface 7 and outer diametrical surface 9 thereof. On the outer diametrical surface 9 of substrate 3, one or more channel regions or depressions 33 may then be formed and configured to fluidly connect with weep holes 31, thereby permitting the liner material (i.e., silicone rubber, etc.), while in its molten state during the molding process, to flow from one surface of the substrate 3 to the other. Consequently, the molten liner material is permitted to flow into the channel regions 33 in the outer surface 9 of the ring substrate 3 and adhere thereto to form an outer aesthetically pleasing design to the ring. Depending on the design contour chosen for the channel(s) 33, the manufacturer can form any aesthetically pleasing design of choice. As an added benefit, in this embodiment, once the liner material cures into a hardened state, the liner material extending through the weep holes 31 to the outer surface 9 of the ring 1 will also function as an added retention member helping to secure liner 5 to the inner diametrical surface 7 of the ring substrate 3, and further prevent dislodgement therefrom.

As previously noted, in one embodiment, liner 5 is adhered to the substrate 3 of ring 1 through the use of an overmolding process. For purposes of illustration, this overmolding process will now be described in reference to the use of silicone rubber as the material for liner 5, and a metallic material, such as titanium or gold for substrate 3. It is to be understood, however, that other materials and processes known to those skilled in the relevant art are also available for adhering liner 5 to the substrate 3 of ring 1. To overmold liner 5 to substrate 3, it is first noted that it is possible for either a standard or self-adhering formulation of silicone rubber to be utilized in the overmolding process. If a standard silicone formulation is used, at least the inner diametrical surface 7 of substrate 3 is preferably cleaned and prepped with a suitable bonding primer. If the silicone being used is a self-bonding formulation, at least the inner diametrical surface 7 of the substrate 3 preferably undergoes a surface modification process to increase the surface energy of the metal substrate, which helps to promote bonding between the liner 5 and substrate 3. After the substrate 3 is properly prepared for the molding process, it is loaded into a steel overmold tool (not shown). The tool is then loaded into a molding press and, depending on the molding process used (compression, transfer, or injection), silicone rubber is then transferred in its molten state into the cavity where the substrate 3 resides, thereby forming liner 5 and bonding it to the substrate 3.

If the ring requires silicone on the outside surface 9 of substrate 3, as shown in FIG. 5, the surface of channel(s) 33 should also be properly prepped in accordance with the material being used. Then, during the overmolding process, the silicone rubber is transferred simultaneously from the inside to the outside surface of substrate 3 via the small weep hole(s) 31 which extend through the wall thereof. Once cured, the inner liner 5 formed on the inner diametrical surface 7 of substrate 3 will be integrally connected through weep holes 31 to an aesthetically pleasing design adhered to the outer surface 9 of the ring 1.

It will, of course, be understood that various changes may be made in the form, details, arrangement and proportions of the parts without departing from the scope of the invention which comprises the matter shown and described herein and set forth in the appended claims.

What is claimed is:

1. A size-accommodating finger ring, comprising:
(a) a finger ring substrate formed about an axis and having an outer diametrical surface and an inner diametrical surface defining a finger-receiving opening therethrough;
(b) a flexible liner attached to said inner diametrical surface of said substrate;
(c) said liner having a plurality of circumferentially-spaced flexible ribs extending radially inward from said liner, each of said ribs having a central radial axis and a pair of opposed sidewalls extending from said liner toward an inner apex, wherein said opposed sidewalls of at least some of said ribs arch toward said central axis thereof to facilitate folding over of said ribs upon transition of said ring on and off the finger.

2. The finger ring defined in claim 1, wherein said liner extends around the entire inner diametrical surface of said substrate and said ribs are spaced about the entire circumference thereof.

3. The finger ring defined in claim 1, wherein said opposed sidewalls of each of said ribs taper generally toward one another from said liner toward said apex thereof.

4. The finger ring defined in claim 1, wherein said liner and said ribs are formed of silicone rubber.

5. The finger ring defined in claim 1, wherein said liner and said ribs are integrally formed of a self-adhering silicone rubber having a hardness value in the range of 20-70 Duro Shore A.

6. The finger ring defined in claim 1, wherein each of said ribs is elongated and extends longitudinally across said liner generally parallel to said axis of said substrate, with said sidewalls of each of said ribs being circumferentially spaced relative to one another.

7. The finger ring defined in claim 1, wherein each of said ribs extends radially inwardly from said liner approximately 0.06 to 0.07 inch.

8. The finger ring defined in claim 1, wherein said ring substrate has an axial width extending between opposite axially spaced peripheral edge portions, and said inner diametrical surface of said substrate defines a raised liner retention shoulder adjacent each of said opposite peripheral edge portions of said substrate.

9. The finger ring defined in claim 8, wherein said liner contours and interengages said raised liner retention shoulder adjacent each of said opposite peripheral edge portions of said substrate to resist axial shearing forces on said liner as said ring transitions on and off the finger.

10. The finger ring defined in claim 9, wherein said shoulder adjacent each of said opposite peripheral edge portions of said substrate extends about the entire circumference of said ring substrate.

11. The finger ring defined in claim 9, wherein said shoulder adjacent each of said opposite peripheral edge portions of said substrate extends radially inward from the remainder of said substrate to a central annular plateau.

12. The finger ring defined in claim 1, wherein said liner is formed of silicone rubber and overmolded to said substrate.

13. The finger ring defined in claim 1, wherein said substrate includes at least one flow-through aperture extending between and connecting said inner diametrical surface and said outer diametrical surface, said liner being formed of a flowable material which extends through said aperture and into connected channel portions formed in said outer diametrical surface to create exterior design indicia in said ring substrate.

14. A size-accommodating finger ring, comprising:
(a) a finger ring substrate formed about an axis with an outer diametrical surface and an inner diametrical surface extending between opposite axially spaced peripheral edge portions, said inner diametrical surface having a radially inward protruding central plateau region defined by a pair of circumferentially extending liner retention shoulders formed one adjacent each of said opposite peripheral edge portions of said substrate;
(b) an inner liner being formed of a flexible plastic material and attached to said inner diametrical surface of said substrate in contouring and interengaging relation with said central plateau region and said liner retention shoulders;
(c) said liner including a plurality of circumferentially-spaced flexible ribs extending radially inward from said liner, each of said ribs having a central radial axis and a pair of opposed sidewalls extending from said liner toward an inner apex, wherein said opposed sidewalls of at least some of said ribs taper inwardly toward said central axis thereof to facilitate folding over of said ribs upon transition of said ring on and off the finger.

15. The finger ring defined in claim 14, wherein said liner is formed of a self-adhering silicone rubber, said liner extending along the entire inner diametrical surface of said substrate with said ribs being spaced substantially equally about the entire circumference thereof.

16. The finger ring defined in claim 14, wherein each of said ribs is elongated and extends longitudinally across said liner generally parallel to said axis of said substrate, with said sidewalls of each of said ribs being circumferentially spaced relative to one another and radiused slightly inwardly toward said central radial axis thereof.

17. The finger ring defined in claim 14, wherein said substrate includes at least one flow-through aperture extending between and connecting said inner diametrical surface and said outer diametrical surface, said liner being formed of a material capable of flowing through said aperture and into connected channel portions formed in said outer diametrical surface to create exterior design indicia in said ring substrate.

18. A size-accommodating finger ring, comprising:
(a) a finger ring substrate formed about an axis and having an outer diametrical surface and an inner diametrical surface defining a finger-receiving opening therethrough, said substrate including at least one flow-through aperture extending between and connecting said inner diametrical surface and said outer diametrical surface;
(b) a flexible liner attached to said inner diametrical surface of said substrate, said liner being formed of a flowable elastomeric material which flows through said aperture in a molten state and into connected channel portions formed in said outer diametrical surface to create exterior design indicia in said ring substrate; and
(c) said liner having a plurality of circumferentially-spaced flexible ribs extending radially inward from said liner, each of said ribs having a central radial axis and a pair of opposed sidewalls extending from said liner toward an inner apex, wherein said opposed sidewalls of at least some of said ribs taper toward said central axis thereof to facilitate folding over of said ribs upon transition of said ring on and off the finger.

19. The finger ring defined in claim 18, wherein said substrate is formed of a metallic material and said liner is formed of a self-adhering silicone rubber.

20. The finger ring defined in claim 18, wherein said outer diametrical surface and said inner diametrical surface extend between opposite axially spaced peripheral edge portions of said substrate, said inner diametrical surface having a radially inward protruding central plateau region defined by a pair of circumferentially extending liner retention shoulders formed one adjacent each of said opposite peripheral edge portions of said substrate to resist axial shearing forces on said liner as said ring transitions on and off the finger.

21. A method of forming a size-accommodating finger ring, comprising the steps of:
(a) providing an annular metal finger ring substrate having an outer diametrical surface and an inner diametrical surface defining a finger-receiving opening therethrough;
(b) preparing said inner diametrical surface of said finger ring substrate to enhance bonding of silicone rubber thereto;
(c) loading said finger ring substrate into an overmold tool, said overmold tool including a defined cavity for receipt of said finger ring substrate, said cavity including defining portions adjacent said inner diametrical surface of said finger ring substrate which define the boundaries of an inner circumferential ring liner with a plurality of circumferentially spaced radially inward extending rib elements; and
(d) transferring molten silicone rubber into said cavity of said overmold tool;
(e) allowing said molten silicone rubber to cure in said cavity, thereby causing said silicone rubber to bond to said inner diametrical surface of said finger ring substrate and form said inner liner.

22. The method of forming a size-accommodating finger ring defined in claim 21, wherein the step of preparing said inner diametrical surface of said finger ring substrate includes modifying said inner diametrical surface to increase the surface energy thereof, and the step of transferring silicone rubber into said cavity of said overmold tool includes the use of a self-adhering silicone rubber material.

23. The method of forming a size-accommodating finger ring defined in claim 21, wherein the step of providing an annular metal finger ring substrate includes providing said substrate with channel portions representing design indicia formed in said outer diametrical surface thereof, and at least one aperture extending through said substrate and connecting said channel portions to said inner diametrical surface of said substrate, such that molten silicone rubber transferred into said cavity of said overmold tool will flow through said apertures and into said channel portions to form design indicia on said outer diametrical surface of said finger ring substrate.
